(19) United States
(12) Patent Application Publication
(10) Pub. No.: US 2024/0229874 A1
(43) Pub. Date: Jul. 11, 2024

(54) MAGNETORHEOLOGICAL BRAKING DEVICE, IN PARTICULAR OPERATING DEVICE

(71) Applicant: INVENTUS Engineering GmbH, St. Anton i.M. (AT)

(72) Inventor: Stefan Battlogg, St. Anton i.M. (AT)

(21) Appl. No.: 18/559,107

(22) PCT Filed: May 5, 2022
(86) PCT No.: PCT/EP2022/062171

§ 371 Date: Nov. 6, 2023

(30) Foreign Application Priority Data
May 6, 2021 (DE) 10 2021 111 904.9

(51) Int. Cl. F16D 57/00

(52) U.S. Cl. CPC F16D 57/002

(57) ABSTRACT

A magnetorheological braking device for braking rotational movements, with an axle unit and a rotary body which is rotatable about the axle unit. The rotatability of the rotary body can be braked in a targeted manner by means of a magnetorheological braking apparatus having a coil unit. A receiving space is formed between the axle unit and the rotary body, which receiving chamber is provided with a magnetorheological medium, the magnetorheological medium comprising magnetorheological particles and gas as a filling medium. The receiving space with the magnetorheological medium is sealed between the axle unit and the rotating body by a sealing device with a sealing unit having a contacting sealing lip.

The present invention relates to a magnetorheological braking device for varying a torque of rotary movements or for braking or decelerating rotary movements. In particular, the invention relates to a magnetorheological operating device for setting operating states at least by means of rotary movements. The braking device has at least one axle unit and at least one rotary body which can be rotated about the axle unit. The rotatability of the rotary body can be set or braked in a targeted manner by means of at least one magnetorheological braking device.

Braking devices of this type enable a particularly targeted deceleration up to and including a blocking of rotational movements. Sometimes the braking devices are designed as operating devices. Such controls are increasingly found in a variety of devices and, for example, in motor vehicles (e.g. control element in the center console, in the steering wheel, on the seat . . . ), in medical technology (e.g. for adjusting medical devices) or in smart devices (e.g. smartphone, smartwatch, computer peripherals, computer mouse, game controller, joystick), OFF-Highway vehicles (e.g. controls in agricultural machinery), boats/ships, airplanes, for example to select menus or to be able to carry out precise controls. By means of the magnetorheological braking device, e.g., different moments, stops and detents for the rotary movement can be set. In this way, a special feel can be achieved when setting operating states (haptic feedback), which supports the user and allows very specific settings and thus the operating complexity to be reduced.

In order to be able to control the magnetorheological braking device in a targeted manner, a sensor device is generally provided for detecting and monitoring the rotational position. However, accommodating them structurally in the braking device entails considerable difficulties, especially if the available installation space is very small.

Further problems arise from the usually very small dimensions of the braking device. So, for example, for a braking device designed as a thumb roller, often only 12 mm in diameter, such as a wheel (roller) that can be rotated with a finger (e.g. thumb) in a steering wheel or a steering wheel spoke of, for example, a motor vehicle (e.g. for adjusting the volume of the infotainment). The installation space for the sensor device is therefore very limited. Overall, this results in a need for optimization in terms of assembly, costs, and installation space.

In the German patent application with the file number 10 2019 129 548.3, which was unpublished before the priority of this application, and the parallel international patent application PCT/EP2020/080613, which was also unpublished before the priority of this application, a magnetorheological operating device for varying a torque of rotary movements is disclosed, with an axle unit being surrounded by a rotary body and a torque for the rotatability of the rotary body being set by means of a magnetorheological braking device. A rotational position of the rotating body is detected with a sensor device. The sensor device has a magnetic ring unit and a magnetic field sensor arranged inside the axle unit.

A disadvantage of the known magnetorheological braking devices and in particular of the magnetorheological operating devices is that the basic torque that can be achieved is relatively high. If a magnetorheological operating device is to be used, for example, in or on a computer mouse, then a high basic torque can lead to an impairment in operation. A high base torque can lead to earlier fatigue of the actuating finger. If you want to specifically slow down or delay the rotation of the mouse wheel and give a haptic tick signal in the form of ticks or a ripple or grid when turning, then the braking force must be controlled specifically and the ticking torque must be higher than the basic torque without generating a braking torque. The user not only has to overcome the basic torque, but also the increased braking torque or ticking torque at the grid points or in between. The user notices haptically not only the difference in torque or the difference in tangential force on the mouse wheel diameter between the basic torque and maximum torque during the tick, but also in which torque range it is. If you start from a very low basic torque, you need less torque stroke to get good haptic feedback. If the mouse wheel is very difficult to move even when at rest and you have to exert yourself, you need a significantly higher increase in braking torque in order to get a clear haptic feedback.

It is therefore the object of the present invention to provide a further improved braking device which enables a lower basic torque and a sufficient ratio of maximum to minimum braking torque (stroke). In particular, a magnetorheological braking device that has a particularly low basic torque is also to be made available for small haptic operating devices.

This object is achieved by a braking device having the features of claim 1. Preferred developments of the invention are the subject matter of the dependent claims. Further advantages and features of the present invention result from the general description and description of the exemplary embodiments.

The braking device according to the invention is magnetorheologically designed and is used to vary a torque of rotary movements and/or to adjust operating states at least by means of rotary movements. The magnetorheological braking device is designed in particular as a magnetorheological operating device or is used as such. The braking device comprises at least one axle unit. The braking device comprises at least one rotating body. The rotating body can be rotated relative to the axis unit or around the axis unit. A rotatability of the rotary body (relative to the axle unit) can be specifically adjusted or braked by means of at least one magnetorheological braking device. The braking device has at least one coil unit. A receiving space is formed between the axle unit and the rotating body, which is equipped with a magnetorheological medium and is sealed (to the outside) via a sealing device. The magnetorheological medium includes magnetorheological particles and gas as a filling medium or essentially consists of them. The filling medium consists in particular essentially of a gas or gas mixture and in particular of air. Particularly preferably no liquid and no oil are included. Oil is not an essential component and preferably not significant and particularly preferably not included in trace amounts.

In any case, oil is not the carrier fluid for the magnetorheological particles. The receiving space with the magnetorheological medium is sealed in particular via a sealing device with a sealing unit with at least one contacting sealing lip between the parts moving towards one another. The parts that move relative to one another are in particular the rotating body and the axle unit, but other parts that are connected to the rotating body and the axle unit can also provide the actual sealing gap. In any case, there is a relative movement between the axis unit and the rotating part.

The braking device according to the invention has many advantages. A significant advantage is that the basic torque can be significantly reduced. The magnetorheological particles generate less friction and thus reduce the basic torque. The sealing device also has less friction, as a result of which the basic torque can be reduced very significantly. A high braking torque can be generated by the magnetorheological particles. The ratio of the maximum torque that can be generated to the basic torque can be increased.

The contact sealing lip of the sealing device can have a low contact pressure and thus low friction. Nevertheless, reliable sealing can be made possible. Only the escape of particles has to be prevented, not the escape of liquid. This also works with a low-friction seal such as a dust seal.

The sealing lip is preferably designed in such a way that there is no liquid seal, but there is a seal with respect to the magnetorheological particles present in the receiving space.

The sealing device preferably comprises an elastic sealing lip with an overlap of less than 0.075 mm.

Preferably, an extension of the unloaded (elastic) sealing lip in the removed state differs by less than 0.06 mm and in particular by less than 0.05 mm from an extension in the installed state. This difference is the coverage. The sealing lip can run radially and/or axially or transversely, i.e., radially and axially. It is important that in one direction of the sealing effect, an extension of the unloaded elastic sealing lip in the removed state only differs by a small extent from an extension in the installed state. With a radial seal, the diameter of the unloaded sealing lip differs only slightly from the diameter of the sealing surface. The exact dimensions also depend on the material used and the dimensions.

A relative difference between an extension of the unloaded elastic sealing lip in the removed state and an extension in the installed state is preferably less than 2.5% or 2% and in particular less than 1.5% or 1% or less than 0.5%.

A sealing surface pressure between the elastic sealing lip and the sealing surface in the installed state is preferably less than 0.075 MPa (megapascal) and in particular less than 0.06 MPa or less than 0.05 MPa.

In all configurations, it is particularly preferred that the sealing device comprises or forms at least one non-contact labyrinth seal with at least one (non-contact) sealing gap. The sealing device can form or have two or more non-contact sealing gaps. A high sealing effect can be achieved with a very low basic torque. Due to the fact that only magnetorheological particles and no liquid are contained, the sealing device can be designed with very little friction.

The sealing gap is preferably so small that the magnetorheological particles are retained, but liquid such as water or oil could pass through.

In all configurations, it is particularly preferred that the sealing device comprises at least one non-contact labyrinth seal with at least one (non-contact) sealing gap. The sealing device is particularly preferably designed as a non-contact sealing device. This can significantly reduce the basic torque will. Due to the fact that only magnetorheological particles and no liquid are contained, the sealing device can be designed without contact.

In all configurations it is preferred that the sealing device (in the basic state) also comprises at least one non-contacting sealing lip. Depending on the operating situation, however, there may occasionally be (light) contact during operation. Preferably the overlap is negative.

In all configurations, the sealing lip can be designed in such a way that in the event of a local accumulation of magnetorheological particles, the gap can be closed and the sealing lip comes into contact. When the accumulation decreases, the sealing lip then springs back and can also release a (small) gap. The free gap can be smaller than 20 pm or 10 pm or 5 pm or pm.

The friction of the contacting sealing lip is preferably low. In particular, a proportion of the friction caused by the sealing lip in the basic state is less than 60% and in particular less than 40%. It is also possible that the friction of the contacting sealing lip affects the basic torque only slightly (by less than 25% or 10%). This can be tested by determining the basic torque with and without the sealing lip touching.

A sealing gap or a sealing lip can run radially and/or axially or also transversely, also radially and axially.

In all configurations it is preferred that the sealing device (in the basic state) comprises a contacting sealing lip. However, depending on the operating situation, there may occasionally be (light) contact during operation. Preferably the overlap is negative. It is also possible for the sealing device to have (at least) one elastic sealing lip with a free sealing gap. A free distance between the elastic sealing lip is then in particular less than 0.075 mm or less than 0.06 mm or less than 0.05 mm.

The receiving space preferably contains more than 40 percent by volume of magnetorheological particles. In the context of this application, the proportion of 40% or 45% or more of magnetorheological particles in the receiving space is understood to mean the proportion by volume. 100% corresponds to the maximum fillable volume. In this respect, the proportion is typically a percentage by volume and also a percentage by mass, at least if the magnetorheological particles each have the same density. However, a proportion of 50% does not mean that 50% of the volume of the receiving space is filled, since the receiving space cannot be completely filled with the magnetorheological particles due to the structure of the magnetorheological particles. Local cavities remain between the individual (dry) magnetorheological particles, which are essentially or completely filled with gas and in particular air.

It has been found that with the use of (dry) magnetorheological particles, the maximum braking torque can also be increased compared to the prior art.

Preferably, the receiving space is more than 50%, 60%, 70% or 80% (percent by volume) filled with magnetorheological particles. Magnetorheological fluids provided with a liquid carrier medium such as oil regularly contain less than 40% or 45% magnetorheological particles. The high and even higher proportion possible here helps to increase the maximum braking torque.

Preferably, the containment space is less than 97 percent or less than 95 percent by volume filled with magnetorheological particles. It has been found that too high a proportion can sometimes, occasionally or regularly lead to a blocking of the braking device. Therefore, a certain distance to the maximum possible filling quantity makes sense. The exact limit depends on the design conditions and the spatial conditions inside the recording room.

A degree of filling (proportion) of the magnetorheological particles is particularly preferably between 70% and 95% of the maximum amount of magnetorheological particles that can be filled.

It is particularly preferred that the magnetorheological particles (each) consist predominantly of carbonyl iron powder. The magnetorheological particles can have coatings to protect against abrasion and/or corrosion and/or additional components in order to make the magnetorheological particles more durable, more abrasion-resistant and/or more slippery during operation. The magnetorheological medium and/or the magnetorheological particles can, for example, include an addition of graphite.

In all configurations, it is possible for a seal, and in particular a graphite seal, to be included axially outside the sensor device. Such a graphite seal can be designed in contact and is not used to seal the magnetorheological particles, but only seals any graphite or other lubricants that may be present and which can be added to the mixture of gas or air and magnetorheological particles.

The rotating body is preferably rotatably mounted to the outside (to a console or a housing). This makes it possible for a gap dimension between the rotating body and the axle unit to essentially not change when pressure is applied to the rotating body (during operation). A bearing point or storage of the rotating body the axle unit is preferably not present.

A core which interacts with the electrical coil unit of the braking device is preferably included. In particular, at least one sensor device is provided at least for detecting a rotary position of the rotary body.

In particular, the sensor device comprises at least one sensor, e.g., a magnetic field sensor. In particular, the sensor is adjacent to the receiving space at the (only) connection point arranged from the receiving space to the outside.

The sensor device particularly preferably comprises at least one magnetic ring unit and at least one magnetic field sensor for detecting a magnetic field of the magnetic ring unit.

The magnetic field sensor is in particular connected to the axle unit in a rotationally fixed manner and is in particular arranged radially and/or axially adjacent to the magnetic ring unit. The magnetic field sensor is preferably arranged at least partially within the axle unit. The axle unit radially surrounds the magnetic field sensor at least in sections (and in particular completely).

The axle unit can in particular comprise at least two separate axle parts which are connected to one another in the axial direction, namely a first axle part and at least one second axle part. The first axle part can consist at least partially of metal and has a lower magnetic conductivity than a core that interacts with an electric coil of the braking device. In particular, the first axle part consists to a considerable extent or predominantly or almost completely or completely of at least one metal or metallic material.

An axle unit of two (or more) connected in axial direction connected axle parts is very advantageous. This makes it possible to manufacture the first axle part from a different material than the second axle part. In particular, the core and the electrical coil unit are accommodated on the second axle part. Therefore, the second axle part is often a geometrically complex component, which is easiest and cheapest in quantities, e.g., an injection molding process is produced.

The first axle part can consist of a more stable or stronger material and the second axle part can be produced in an injection molding process and consist partially or predominantly of plastic.

It is also possible for the axle unit to be in one piece and to consist partially, predominantly or entirely of plastic or metal and to have a lower magnetic conductivity than a core that interacts with an electric coil of the braking device. A ratio of the magnetic conductivity of the core to a magnetic conductivity of the axle unit (or the first axle part) is preferably greater than 10 or greater than 100 or greater than 1000 and can preferably reach and exceed values of 10,000 or 100,000. The magnetic conductivity is the “relative magnetic permeability”, which is also simply called “magnetic permeability”.

In all configurations it is preferred that the first axle part comprises a deep-drawn part or is formed from it. This enables cost-effective production.

The axle unit (or the first axle part) particularly preferably consists to a considerable extent, predominantly, almost completely or completely of a paramagnetic material. Production from diamagnetic materials is also possible and preferred. The first axle part particularly preferably consists to a considerable extent or predominantly or completely of at least one material or austenitic steel with a magnetic permeability of less than 10 or 20. The magnetic permeability after a deep-drawing process for production and shaping is particularly preferably less than 10 or 20 and in particular smaller 5.

In a specific embodiment, the first axle part is a deep-drawn part and is a low-carbon, austenitic and rustproof stainless steel with the designation 1.4303 or X4CrNil8-12. In this case, the second axle part (also called the stator) is made of PPS GF 40 (a thermoplastic with 40% glass fiber reinforcement). Other materials are also possible.

It is also possible and preferred that the axle unit consists entirely of fiber-reinforced plastic such as PPS GF 40.

In all configurations it is preferred that the core and/or the coil unit is/are accommodated on the axle unit (or the second axle part).

In advantageous developments, the magnetorheological braking device comprises at least one shielding device for at least partially shielding the sensor device at least from, for example, external magnetic fields and/or a magnetic field of a coil unit of the braking device. In this case, the shielding device comprises in particular at least one shielding body which at least partially surrounds the magnetic ring unit. In particular, the shielding device comprises at least one separating unit arranged between the shielding body and the magnetic ring unit. The separating unit has a lower magnetic conductivity than the shielding body, with a ratio being in particular less than 1/10 or 1/100. In particular, at least one holding device is included, which at least partially covers the shielding device in particular non-rotatably connects or couples to the rotary body.

Such a shielding device and also the holding device offer a considerable advantage. As a result, the sensor device can be shielded from disruptive influences particularly effectively and at the same time in an uncomplicated and space-saving manner. This enables a significantly improved detection of the rotational position.

In particular, the shielding device comprises at least one magnetic decoupling device arranged between the shielding body and the rotating body. In this case, the separating unit and/or the decoupling device preferably have a magnetic conductivity (relative magnetic permeability) that is (much or a multiple) lower than that of the shielding body and/or the core. A ratio of the two is preferably less than 1/10 or 1/100.

In particular, the holding device provides the decoupling device. The decoupling device can be provided entirely by the holding device. Then the holding device corresponds in particular to the decoupling device. Then the terms holding device and decoupling device can in particular be used synonymously and can therefore be exchanged. The holding device can include the decoupling device or be designed as such. The decoupling device and the holding device can also be designed separately, at least in part. The decoupling device and the holding device can be separate components.

It is possible and advantageous for the holding device to be designed in at least two parts. In particular, the holding device then comprises at least one first holding component, which is designed to be magnetically conductive. In particular, the holding device then comprises at least one second holding component, which is designed to be magnetically non-conductive. The second holding component preferably has a magnetic conductivity (magnetic permeability) that is (much or a multiple) lower than that of the shielding body. In particular, the second holding component includes the decoupling device or is designed as such. The holding device can be designed to be at least partially magnetically conductive. The holding device can be designed to be at least partially magnetically non-conductive.

In other, simple configurations, it is preferable for the holding device to consist essentially or entirely of a (good) magnetically conductive material, and for the shielding body to be formed directly on the holding device. In a preferred simple configuration, the shielding body is formed by a section of the holding device. The shielding body is then formed in one piece with the holding device. If the shielding body formed on the holding device surrounds the sensor device and in particular the magnetic ring unit radially outwards (almost completely) and axially outwards (almost completely) covers it, apart from the passage of the axis unit, there is a very high level of shielding from external magnetic fields and a significant improvement of the measurement result.

In particular, it is provided that the holding device at least partially connects the shielding body and/or the separating unit and/or the magnetic ring unit (and/or the decoupling device) to the rotary body in a rotationally fixed manner.

In the context of the present invention, braking or deceleration is understood to mean, in particular, the application of a (rotary) moment. A (rotary) movement can be delayed and in particular also blocked by the moment. Due to the torque, rotation can preferably also be braked and in particular blocked from a standstill. In particular, the terms braking and decelerating are used synonymously within the scope of the present invention and can therefore be interchanged.

It is possible and advantageous for the rotary body and/or the shielding body and/or the decoupling device to be connected at least partially in one piece to the holding device. The rotary body and/or the shielding body and/or the decoupling device can also be designed separately from the holding device. In particular, the separating unit is designed separately from the holding device and consists of a different material.

It is also possible and advantageous for the rotary body and/or the shielding body and/or the separating unit and/or the decoupling device to be at least partially mounted on the holding device. Then the separate components can be mounted in particular on the holding device and/or on one another.

The holding device can have at least one fastening device, which is designed for fastening at least one additional part, in particular an additional part of a finger roller. The additional part is in particular the additional part described in more detail below.

In a further development, the holding device comprises at least one (in particular magnetically conductive) path extending between the rotating body and the shielding body. The distance corresponds to at least a third and preferably at least a quarter and preferably at least half of a maximum (in particular outer) diameter of an electrical coil of the coil unit (in particular in a radial direction within the coil plane). As a result, the decoupling device can be dispensed with in certain applications without an undesirable effect on the magnetic field sensor occurs. Depending on the geometry of the holding device, e.g., a field strength of an operationally present in the rotary body magnetic field can be reduced by half or more along the path to the shielding body. The distance runs in particular over a sleeve-like part of the holding device that includes a central radial recess.

In particular, the shielding device is suitable and designed to shield a magnetic field of the braking device, in particular the coil unit, in such a way that it does not scatter into the sensor device and adversely affect the detection of the magnetic field of the magnetic ring unit.

In particular, the shielding body is not arranged between the magnetic field sensor and the magnetic ring unit. In particular, the shielding body is arranged between the magnetic field sensor and the magnetic ring unit in such a way that the shielding body does not (undesirably) shield the magnetic field sensor from the magnetic field of the magnetic ring unit to be detected.

In an advantageous embodiment, the shielding body surrounds the magnetic ring unit at least in sections on a radial and/or axial outside. It is also preferred and advantageous that the shielding body surrounds the magnetic ring unit at least in sections on at least one axial inner side, which faces away from the coil unit of the braking device.

In particular, the shielding body is designed as a shielding ring. In particular, the shielding ring has an L-shaped cross section. The shielding ring can also have a U-shaped cross section. The shielding body can also be designed as a cylindrical ring section). Other suitable geometries are also possible, which at least partially extend around the magnetic ring unit. The shielding ring can be formed in one piece. A multi-part design is also possible. In particular, the magnetic ring unit is partially arranged radially inside the shielding ring. This offers a compact arrangement and effective shielding.

In a preferred and advantageous embodiment, the separating unit comprises at least one gap running between the shielding body and the magnetic ring unit. In particular, the separating unit also includes at least one filling medium arranged in the gap. In particular, the filling medium is a casting compound for subsequent filling of the gap. In particular, at least one plastic is provided as the filling medium. In particular, the filling medium is suitable and designed to firmly connect the shielding body to the magnetic ring unit. It is also preferred and advantageous that air is provided as the filling medium.

In all configurations it is preferred that the magnetic ring unit is connected to the rotating body in a rotationally fixed manner. If air is provided as the filling medium, at least one connecting element and, for example, a front disk or the like can be provided for the non-rotatable connection of the magnetic ring unit to the rotating body. The connecting element preferably has the magnetic properties described for the separating unit with regard to its magnetic permeability.

In particular, the filling medium is suitable and designed to mechanically and preferably non-rotatably connect the magnetic ring unit to the shielding body. This enables a particularly compact design, since attachment and shielding are achieved at the same time. In particular, the filling medium and the magnetic ring unit are rotatably mounted relative to the axle unit.

In particular, the magnetic ring unit is non-rotatably connected to the holding device by means of the separating unit and/or the shielding body and optionally connected to the decoupling device. Preferably, the holding device is at least indirectly non-rotatably connected to the rotary body. The rotational movement of the rotating body can thus be transmitted to the magnetic ring unit in a space-saving and reliable manner by means of the shielding device. The rotary body can be radially surrounded by at least one additional part. The holding device or the decoupling device can be connected to the rotary body in a rotationally fixed manner via the additional part. The holding device can also be directly non-rotatably connected to the rotary body. In particular, the magnetic ring unit and the separating unit and the shielding body (and the decoupling device) are rotatably mounted relative to the axle unit. In particular, the holding device is rotatably mounted relative to the axle unit.

The or at least one sealing device is preferably attached to the holding device. In particular, the sealing device rests either on the rotary body and/or on the axle unit. In particular, the sealing device is suitable and designed to counteract the emergence of a magnetorheological medium, which is arranged in a receiving space, of the braking device. Such component integration allows the braking device to be made even more compact. In particular, magnetorheological particles are held back.

It is possible and preferred for the rotating body to protrude beyond the last axial braking body by no more than half the axial width of a braking body of the braking device. In particular, the rotating body protrudes beyond that axial end which faces the magnetic ring unit. In particular, the rotating body does not protrude beyond the last axial brake body at this axial end. The rotary body can also be set back from the last axial brake body. Such configurations can advantageously also be at both axial ends or at the opposite end of the magnetic ring unit end planned. Such a shortening of the rotating body is particularly advantageous in order to further reduce the scattering effect of the magnetic field of the braking device in the sensor device.

In a particularly advantageous embodiment, the rotary body is radially surrounded by at least one additional part. In this case, the rotary body is set back axially at least at that axial end of the axle unit in relation to the additional part on which the magnetic ring unit is arranged. In particular, the additional part protrudes beyond the rotary body at this axial end. The rotary body is preferably set back at both axial ends in relation to the additional part. In particular, the axial length of the rotating body is less than the axial length of the additional part. This also further improves the magnetic decoupling considerably.

In all configurations it is particularly preferred and advantageous that the shielding body has a relative magnetic permeability of at least 1000 and preferably at least 10,000 and particularly preferably at least 100,000 or at least 500,000. The shielding body preferably has at least the relative magnetic permeability of the rotating body. The magnetic properties of the shielding body described here are preferably also provided for the rotary body.

In particular, the shielding body comprises at least one ferromagnetic material or consists of such a material. Preferably, such materials are also provided for the rotary body.

In a particularly advantageous embodiment, the shielding body comprises at least one (in particular soft magnetic) nickel-iron alloy with nickel-iron alloy with 60% to 90% nickel and proportions of copper, molybdenum, cobalt and/or chromium or consists of one. A proportion of 69% to 82% and preferably 72% to 80% nickel can also be provided be. Such a configuration is preferably also provided for the rotary body. The shielding body and/or the rotating body particularly preferably comprises at least one meta-metal or consists of such a metal.

It is advantageous and preferred that the decoupling device and/or the separation unit (in particular its full medium) and/or at least the additional part have a relative magnetic permeability of a maximum of 1000 and preferably a maximum of 100 and particularly preferably a maximum of ten or a maximum of two. It is also preferred and advantageous that the aforementioned components have a relative magnetic permeability of a maximum of one thousandth of the relative magnetic permeability of the shielding body and/or a relative magnetic permeability between 1 and 2. In particular, the aforementioned components include or consist of a paramagnetic material. It is also possible and preferred that the aforementioned components include or consist of a diamagnetic material.

The magnetic properties of the separating unit described above are preferably also provided for the axle unit. In this way, no disruptive stray field is generated by the axle unit in the magnetic field sensor. For example, the axle unit is made of a plastic, in particular fiber-reinforced.

The coil unit of the braking device can be arranged radially in relation to the axle unit. It is also possible for the coil unit to be arranged axially in relation to the axle unit. In such an axial arrangement, the coil unit extends with its main plane in particular along a longitudinal axis of the axle unit.

The arrangement of the magnetic field sensor offers a considerable advantage. This is a space-saving accommodation with a particularly short tolerance chain of the components (low total tolerance or few components between the sensor attachment and the magnet attachment) and at the same time enables a particularly reliable sensory detection. The connection of the magnetic field sensor to the axle unit offers a particularly tolerance-optimized integration.

The rotary body is preferably designed as a finger roller and particularly preferably as a thumb roller. The rotary body is preferably designed as a cylindrical component which is set in rotation by means of at least one finger. The rotary body can also be part of a computer mouse. In particular, the braking device is intended to be operated with just one finger. In particular, the braking device is suitable and designed to be operated in a lying position. In particular, the axis of rotation of the rotary body assumes a more horizontal than vertical position. However, it is also possible for the braking device to be operable in a standing position (vertical orientation). In this case, the braking device is in particular usually encompassed by two or more fingers. The rotary body can also be designed as a rotary knob or the like and in particular contain at least one push function and/or pull function (push and/or pull). This push/pull function can be used, for example, to select or confirm selected menus.

In particular, the rotating body or the finger roller has a diameter of less than 50 mm and preferably less than 20 mm and particularly preferably less than 15 mm. For example, the rotating body has a maximum diameter of 12 mm. However, larger or smaller diameters for the rotating body are also possible and advantageous for certain applications. xxx

In all of the configurations, it is possible and preferred for the rotary body to be equipped with at least one additional part. Preferably, the additional part surrounds the rotary body radially and preferably sleeve-like. The additional part can also close the rotary body on at least one end face. In particular, the additional part is designed as an additional sleeve, which is at least partially and preferably completely closed on at least one axial end face. This relates in particular to that axial end face of the additional sleeve which is arranged on the end of the axle unit which is remote from the magnetic ring unit. It can be provided that the rotary body is designed as a hollow-cylindrical sleeve part that is open at the end faces.

In particular, the additional part is designed as an additional sleeve pushed over the rotary body. In this case, the additional part can have local increases in the outer diameter. For example, the additional sleeve has a circumferential elevation. In particular, the additional part is used to increase the diameter of the rotary body. The additional part can also be designed as a ring or the like or at least include one. To improve the feel, the additional part can be provided with at least one contour and in particular can be corrugated and/or rubberized or the like.

The magnetic ring unit is preferably arranged on an axial end face of the rotary body. This offers a particularly advantageous accommodation of the magnetic ring unit. The magnetic ring unit can be attached directly to the axial end face. However, it is also possible for the magnetic ring unit to be attached to the axial end face of the rotary body via at least one connecting element. It is also possible for the magnetic ring unit to be arranged on the axial end face of the rotary body and to be attached to a different position of the braking device via corresponding connecting elements. xxx

It is preferred and advantageous that the magnetic ring unit surrounds the magnetic field sensor at least in sections in the manner of a ring. In particular, the magnetic ring unit is radially around the magnetic field sensor arranged around. In particular, the magnetic field sensor is arranged centered on the magnetic ring unit in the axial direction. This means that the magnetic field sensor is arranged in the same axial longitudinal position as the magnetic ring unit. However, the magnetic field sensor can also be arranged offset in the axial direction with respect to the magnetic ring unit. In the context of the present invention, such position information and in particular the information “radial” and “axial” relates in particular to an axis of rotation of the rotary body.

It is also preferred and advantageous that the magnetic ring unit and the magnetic field sensor are arranged in a coaxial manner with respect to one another. This offers a particularly space-saving accommodation even with particularly small dimensions and, for example, with a thumb roller. In particular, the magnetic field sensor is surrounded by the magnetic ring unit. The magnetic field sensor is in particular centered axially and/or radially with respect to the magnet ring unit. In particular, the magnetic field sensor has a specific radial offset to the axis of rotation of the magnetic ring unit. However, the magnetic field sensor can also be offset from the magnetic ring unit, at least in the axial direction.

It can be provided that the magnetic field sensor is arranged offset to the axis of rotation of the magnetic ring unit. This can also be provided if a central arrangement for the magnetic field sensor is provided overall, for example if the magnetic field sensor is arranged within the axle unit and is surrounded in a ring shape by the magnetic ring unit. An improved measurement of the angle of rotation is possible through a targeted offset of the magnetic field sensor in relation to the axis of rotation of the magnetic ring unit. For example, even with only two poles of the magnetic ring unit, each rotational position can be precisely defined and thus each angle can be measured as accurately as possible. An absolute encoder can thus be implemented with particularly little effort. The magnetic field sensor is arranged inside the axle unit.

This offers a particularly compact and at the same time tolerance-optimized accommodation of the magnetic field sensor. For this purpose, the axle unit has in particular at least one receptacle or bore in which the magnetic field sensor is arranged. In the context of the present invention, a receptacle or bore is also understood to mean, in particular, all other suitable passage openings, regardless of whether they are produced by means of a drilling process or not. The receptacle or bore runs in particular in the longitudinal direction of the axle unit. The receptacle or bore is, in particular, designed to be continuous or can also be designed as a blind hole.

In particular, the magnetic field sensor is arranged in the center of the axle unit. In particular, at least one active sensor section of the magnetic field sensor is arranged within the axle unit. The entire magnetic field sensor is preferably arranged inside the axle unit. Within the scope of the present invention, the position information for the magnetic field sensor relates in particular to at least the active sensor section.

The magnetic field sensor is preferably arranged in the bore of the axle unit, through which at least one electrical connection of the braking device also runs. The electrical connection includes in particular at least one supply line and/or control line for the coil unit. This offers an advantageous utilization of the installation space and at the same time enables a particularly uncomplicated transmission of the sensor signals. In particular, the electrical connection emerges from the front of the axle unit.

The magnetic field sensor is arranged in particular on at least one printed circuit board. The printed circuit board is, for example, a print or at least includes one. At least the braking device, in particular the coil unit, is preferably electrically connected to the circuit board. At least one connection line for contacting the braking device is preferably also connected to the printed circuit board. It is preferred and advantageous that the printed circuit board is arranged inside the axle unit. It is also preferred that the connection line extends out of the axle unit.

In particular, the circuit board is arranged in the previously described hole. In particular, the connection line runs through the bore. In particular, the connecting line emerges from the axle unit on a front side. This offers a particularly uncomplicated and quick installation and at the same time a compact accommodation of the corresponding components.

In particular, the connection line comprises at least one plug unit. For example, a connector unit with six or eight pins is provided. In this way, the braking device can be connected particularly quickly and at the same time reliably to the component to be operated and, for example, to vehicle electronics. The control unit can also be fixed in the installation position (e.g. holder of the control unit) by plugging in the plug.

The magnetic field sensor is preferably cast in the axle unit and/or overmolded with at least one material. In particular, the bore is at least partially filled with the material for this purpose. The printed circuit board in the axle unit is particularly preferably encapsulated with at least one material. A plastic or another suitable material is preferably provided. In this way, the magnetic field sensor or the printed circuit board can be reliably protected from external influences and at the same time be attached in a simple manner.

In an advantageous embodiment, the magnetic field sensor is arranged on an axial and of the axle unit on the face side and particularly preferably centered on the face side. This accommodation offers advantages in terms of sensor quality as well as installation effort and space requirements. In particular, the magnetic field sensor is arranged on that end face of the axle unit which is arranged inside the rotary body.

In this case, the magnetic ring unit is preferably arranged outside of the rotary body. However, the magnetic ring unit can also be arranged inside the rotary body. In such a configuration, the magnetic field sensor can be arranged offset relative to the magnetic ring unit in relation to the axial direction. However, the magnetic field sensor can also be in the same axial longitudinal position as the magnetic ring unit.

In particular, the magnetic field sensor is attached directly to the axle unit. For example, the magnetic field sensor can be connected to the axle unit by means of overmolding or the like. However, it is also possible for the magnetic field sensor to be attached to the axle unit by means of at least one connection structure. The magnetic field sensor can also be embedded at least partially in the end face of the axle unit. It can also be provided that the magnetic field sensor is arranged radially on an axial end of the axle unit.

In particular, the magnetic ring unit surrounds the axle unit at least in sections in the manner of a ring. In particular, the magnetic ring unit is arranged radially around the axle unit. In particular, the magnetic ring unit is arranged in relation to the longitudinal direction of the axle unit. In particular, the magnet ring unit and the axis unit are arranged in a coaxial manner with each other. The axle unit is preferably in the center of the arrangement.

External storage of the rotary body is particularly preferred. It is also possible for the rotary body to be rotatably mounted on the axle unit by means of at least one bearing device.

The braking device preferably comprises at least one wedge bearing device. The braking device can also be assigned at least one wedge bearing device. The wedge bearing device in particular comprises at least one and preferably a plurality of brake bodies. The brake bodies are designed in particular as rolled bodies. Cylindrical and/or spherical brake bodies can be provided. The wedge bearing device is in particular designed as a rolling bearing or at least includes one.

It is also possible for the brake bodies to be formed on the outer circumference of the core or to be connected thereto in a rotationally fixed manner. The braking bodies can form a type of external toothing or braking elements protruding outwards, which form constrictions for the magnetorheological particles, where clusters of particles linked together form when a magnetic field is applied. Such braking elements can also be referred to as magnetic field concentrators.

The braking device is particularly suitable and designed for specifically dampening and/or delaying and/or blocking the rotatability of the rotary body by means of the wedge bearing device and the coil unit and the magnetorheological medium. The braking device is particularly suitable and designed to use the wedge bearing device and the coil unit and the magnetorheological medium to also specifically reduce a moment for the rotatability of the rotary body again after a delay or blockage.

The wedge bearing device with the braking bodies or braking elements is preferably arranged axially between the magnetic ring unit and the coil unit. This results in a particularly advantageous spacing of the magnetic ring unit from the magnetic field of the coil unit.

The damping takes place in particular via the so-called wedge effect, which in previous patent applications applicant (e.g. in DE 10 2018 100 390.0 or in DE 10 2020 106 328.8). For this purpose, braking bodies or braking elements are located on the rotating body adjacent to the coil unit and to the core. The brake bodies are then surrounded by magnetorheological particles. The magnetic field of the coil unit passes through the housing of the rotating body through the roller body/brake elements and closes through the core. In the process, wedges form on the magnetorheological particles, which slow down the movement of the rotary body. The braking bodies can be balls, cylindrical rollers or other parts, or they can be connected to the core in a fixed and non-rotatable manner.

It is possible for the magnetic field sensor and in particular also the magnetic ring unit to be arranged on that end face of the rotary body on which there is also an end face of the axle unit from which at least one signal line of the magnetic field sensor emerges, so that the signal line does not run through a magnetic field of the braking device. This has the advantage that the signals from the magnetic field sensor are not disturbed by the magnetic field of the coil device. In particular, the connecting line of the braking device is also arranged on this end face.

In all configurations it is particularly preferred that the magnetic ring unit and/or the magnetic field sensor are arranged within a peripheral line delimited by the rotating body. In particular, the magnetic ring unit and/or the magnetic field sensor do not protrude beyond the circumference of the rotary body. In particular, the magnetic ring unit and the magnetic field sensor are arranged radially inside of the peripheral line of the rotating body. In particular, the peripheral line is delimited by the rotating body itself and not by an additional part arranged on the rotating body.

As a material for the rotating body, for example, a nickel-iron alloy with, for example, 69-82% nickel provided. are also possible other metals that shield the magnetic field (so-called m-metals). In particular, the wall has a relative magnetic permeability of at least 300 or at least 1000 and preferably at least 10,000 and particularly preferably at least 100,000 or at least 500,000.

It is also possible and preferred that a wall at least partially closes an open end face of the rotary body. Then it is preferred that the axle unit extends through the wall. The wall then has in particular at least one through-opening for the axle unit.

It is also possible and advantageous for the wall to be designed as a support structure for the sealing device. In particular, at least one sealing section for the axle unit and the rotary body is fastened to the wall. In such embodiments, the wall is attached in particular to the axle unit.

In an advantageous development, it is preferably provided that the sensor device is suitable and designed to also detect at least one axial position of the rotating body in relation to the axle unit in addition to the rotational position of the rotating body.

In particular, the magnetic field sensor is then designed as a three-dimensional magnetic field sensor. In particular, the axial position is detected by means of the magnetic ring unit. In particular, the axial position is detected by means of an axial position of the magnetic ring unit relative to the magnetic field sensor. Such a configuration is particularly advantageous for a braking device in which the operating states are also set by means of pressure movements. In particular, the braking device is suitable and designed to also set operating states by means of at least one pressing movement. The pressure movement takes place in particular in the direction of the axis of rotation for the rotary movement of the rotating body.

In order to detect the axial position of the rotary body in relation to the axle unit, it is preferably provided that the magnetic ring unit surrounds the magnetic field sensor in a ring-like manner at least in sections. The magnetic field sensor is preferably arranged with an axial offset to the axial center of the magnetic ring unit. This enables a particularly precise and high-resolution detection of the axial position. At the same time, the axial direction of movement can also be reliably detected. In particular, the magnetic field sensor is arranged radially centered in relation to the magnetic ring unit.

The sensor device is preferably suitable and designed to determine the axial position of the rotary body in relation to the axle unit from the intensity of the magnetic field of the magnetic ring unit detected by the magnetic field sensor. In articular, the sensor device is suitable and designed to determine an axial direction of movement of the rotating body in relation to the axle unit from a sign of a change in the intensity of the magnetic field of the magnetic ring unit. However, it is also possible for the magnetic field sensor to be arranged in the axial center of the magnetic ring unit.

In particular, the axle unit is designed to be stationary. In particular, the axle unit is accommodated on a bracket which provides a support structure for components accommodated thereon and in particular for the rotary body mounted thereon and/or for the braking device and/or for the sensor device. In particular, a longitudinal axis of the axle unit provides the axis of rotation of the rotating body. In particular, the axle unit and the rotary body are arranged in a coaxial manner with each other.

The rotary body is designed in particular in the manner of a sleeve. The rotating body consists in particular of a magnetically conductive material and preferably of a metallic and especially preferably made of a ferromagnetic material. In particular, the rotating body comprises at least one rotating sleeve or is designed as such. The rotary sleeve can also be referred to as a sleeve part. The rotary body is designed in particular as a rotary knob. In particular, the rotary body is of cylindrical design. The rotary body has in particular two end faces and a cylindrical wall extending between them. In this case, the rotary body preferably has at least one closed end face. It is also possible that both end faces are at least partially closed.

In particular, the axle unit extends into the rotating body and preferably into its receiving space. In particular, the rotary body is designed and arranged on the axle unit in such a way that the axle unit extends out of the rotary body at an open end face. In this case, in particular, the other end face of the rotary body is closed.

The braking device and preferably at least the coil unit are arranged in particular in a rotationally fixed manner on the axle unit.

In particular, the braking device can be controlled as a function of at least one signal detected by the sensor device. A control device for controlling the braking device as a function of the sensor device is preferably provided. In particular, the control device is suitable and designed to generate a targeted magnetic field with the coil unit as a function of the signal from the sensor device. The braking device is in particular also a damping device.

In particular, the wedge bearing device, preferably its brake body, is (directly) surrounded by the medium. The wedge bearing device surrounds the axle unit, in particular radially.

The sensor device is in particular as an absolute encoder educated. The sensor device can also be designed as an incremental encoder or as another suitable design. The sensor device is in particular operatively connected to the control device and/or the braking device.

The magnetic ring unit is in particular designed to be closed in the form of a ring. The magnetic ring unit can also be open in the form of a ring. In particular, the magnetic ring unit comprises at least one permanent magnet or is designed as such. In particular, the magnetic ring unit provides at least one magnetic north pole and at least one magnetic south pole. In particular, at least one shielding device for shielding its magnetic field from the magnetic field of the coil unit is assigned to the magnetic ring unit. The shielding device comprises in particular the wall described above or is provided by it.

The magnetic field sensor is particularly suitable and designed to detect the orientation of the magnetic field of the magnetic ring unit. In particular, the magnetic field sensor is designed as a Hall sensor or includes at least one. Other suitable sensor types for detecting the magnetic field of the magnetic ring unit are also possible.

A braking device suitable for use with the invention is also described in patent application DE 10 2018 100 390 A1. The entire disclosure of DE 10 2018 100 390 A1 is hereby part of the disclosure content of the present application.

The applicant reserves the right to claim a computer mouse with at least one braking device, as described above. In this case, the braking devices are provided in particular by a mouse wheel on the computer mouse or a similar input device. In particular, a stationary holder is included. In particular, the axle unit is non-rotatably connected to the holder and extends in the axial direction. In particular, the rotary body comprises a rotary part which can be rotated about the axle unit and is hollow (and cylindrical on the inside). In particular, a circumferential gap is formed between the axle unit and the rotary body. In particular, the gap is at least partially filled with a magnetorheological medium and here with magnetorheological particles and air or the like.

Specifically, a core made of a magnetically conductive material extending in the axial direction and an electric coil (coil unit) are accommodated on the axle unit. In particular, the coil is wound around the core in the axial direction and in particular spans a coil plane, so that a magnetic field of the electric coil extends transversely (to the axial direction) through the axle unit. In particular, a maximum (outer) diameter of the electric coil in a radial direction inside the coil plane is larger than a minimum (outer) diameter of the core in a radial direction transverse (perpendicular) to the coil plane.

Overall, the invention provides an advantageous braking device that includes a magnetorheological braking device. The braking device can be produced very inexpensively and can also be implemented under high cost pressure.

The axle unit accommodates the magnetic field sensor in the interior. The internal magnetic field sensor is arranged in particular on a printed circuit board and, together with the printed circuit board (PCB), requires a certain installation space, i.e., a minimal inner diameter. With the previous version, this can only be reduced minimally without deteriorating the sensor quality and driving up the component prices. The forces and moments to be transmitted therefore define the component cross-section. When used as a computer mouse wheel, the rotor can be rotated 360 degrees up to million times. Each revolution can have 24 ticks, for example, which means that there are several million load changes (basic torque+tick torque/basic torque), i.e., a high alternating load. Everything together should cost as little as possible.

Further advantages and features of the present invention result from the description of the exemplary embodiments, which are explained in the following with reference to the accompanying figures.

In the figures show:

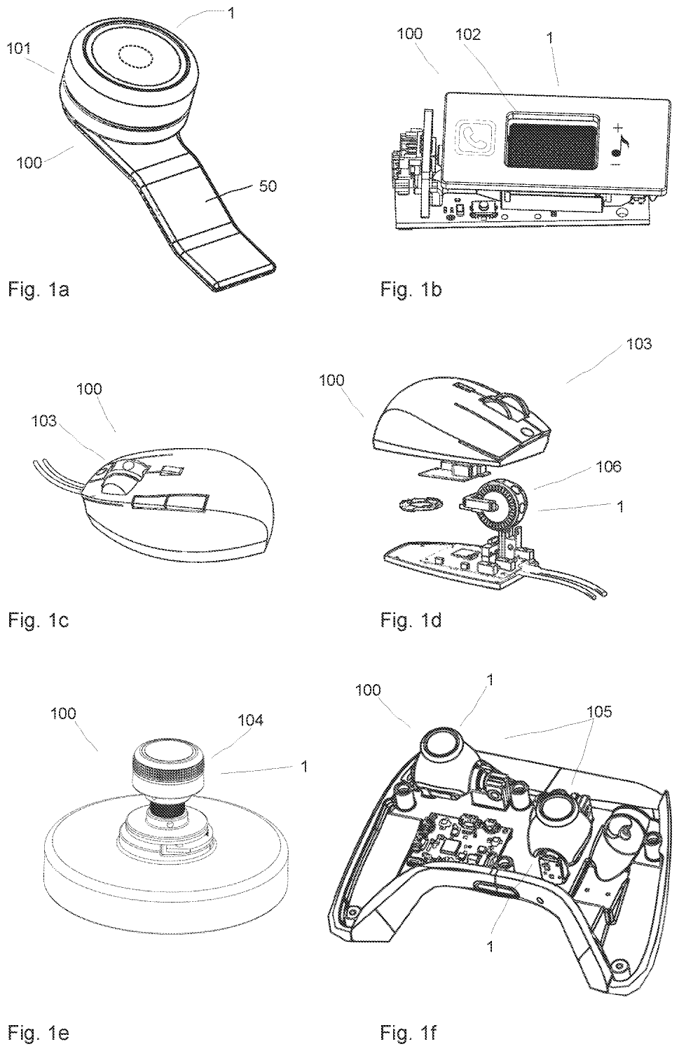

FIG. 1a-1e show schematic three-dimensional views of braking devices;

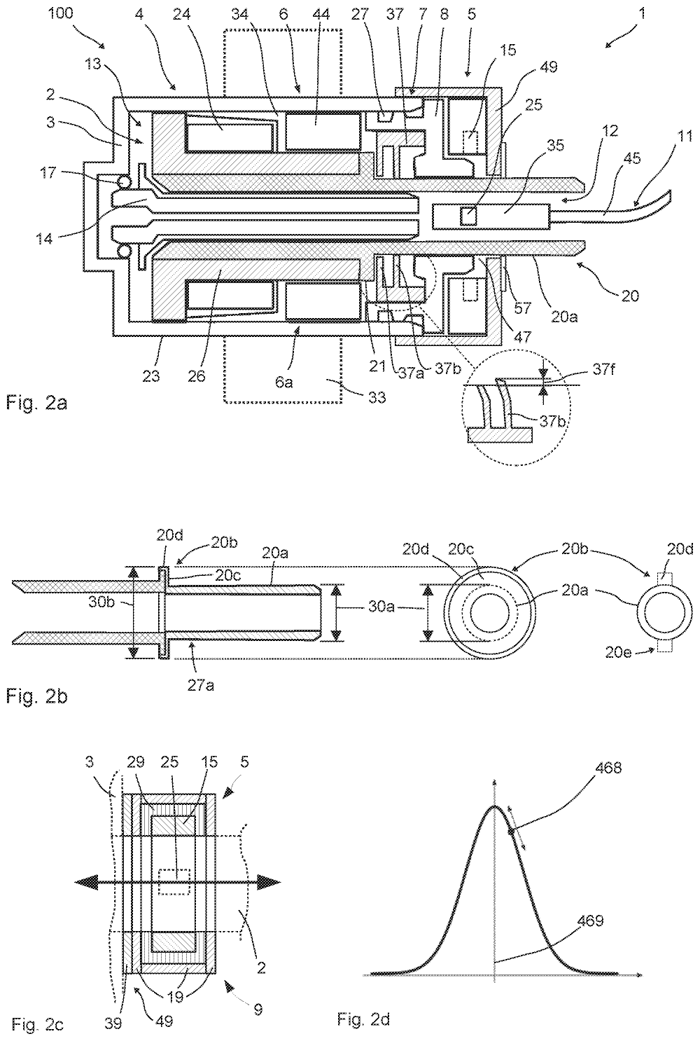

FIG. 2a is a purely schematic representation of a braking device in a sectional side view;

FIG. 2b shows schematic detailed representations of the braking device according to FIG. 2a;

FIG. 2c-2d show detailed views of the braking device of FIG. 2;

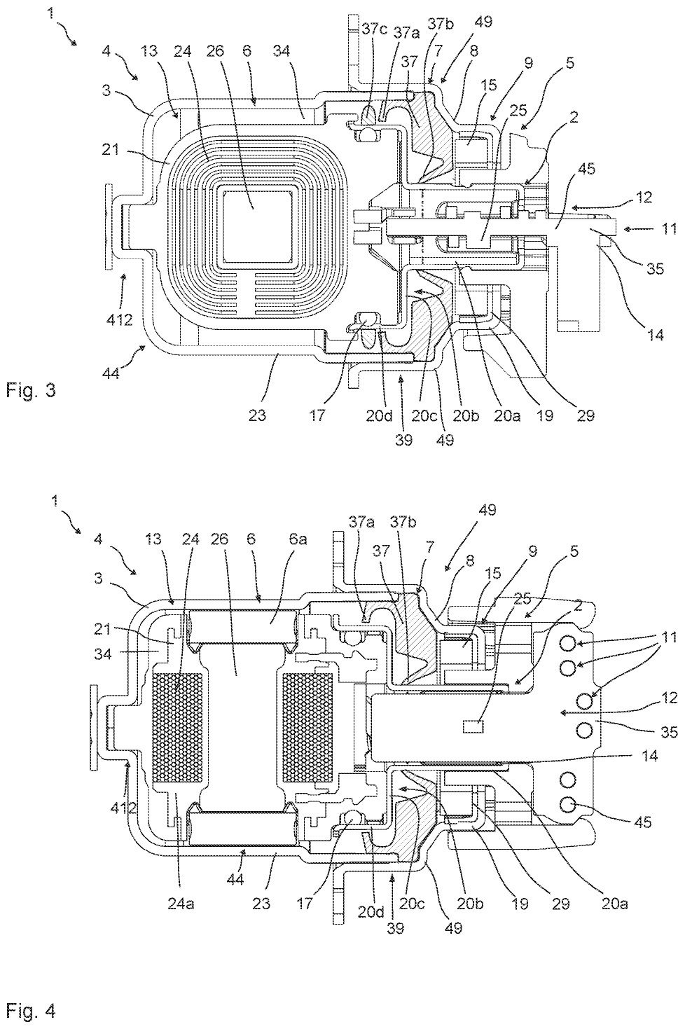

FIG. 3-9 show different views of further embodiments of a braking device according to the invention;

FIG. 10 is a schematic representation; and

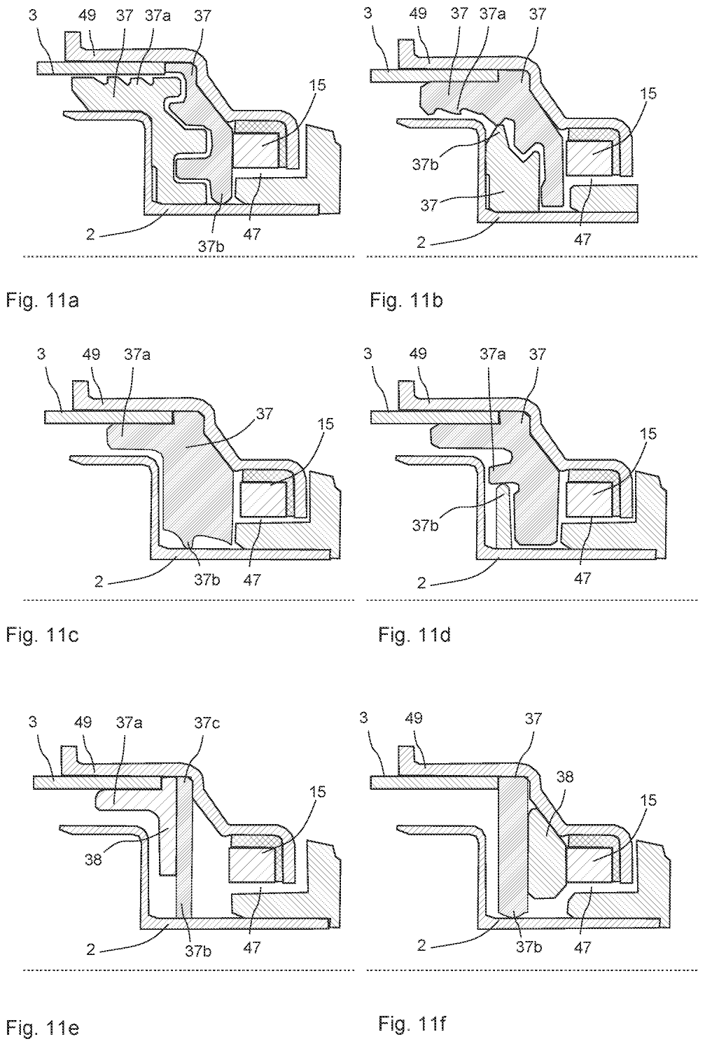

FIG. 11a-f show different views of further embodiments of a braking device according to the invention.

FIGS. 1a to 1e show devices that are equipped with the invention. The braking devices are each designed as a haptic operating device 100 here.

FIG. 1a shows a haptic control knob 101. The control knob is attached via a console 50. The control button 101 is about the sleeve part operated. The user interface can also be used to transmit information.

In FIG. 1b, the braking device 1 is shown as a thumb roller 102 with a haptic operating device 100. The thumb roller 102 can preferably be used in steering wheels, for example. However, the thumb roller is not limited to this use case. Depending on the installation situation, the thumb roller 102 can generally also be used with any other finger.

In FIGS. 1c and 1d, the braking device 1 according to the invention is designed as a mouse wheel 106 of a computer mouse 103. The magnetorheological braking device can be used to control haptic feedback.

FIG. 1e shows a joystick 104 with a braking device 1 as a haptic control device 100. FIG. 1f shows a gamepad 105 with the braking device 1 to give the player haptic feedback depending on the game situation.

FIG. 2a shows a braking device 1, which is designed here as an operating device 100 and has a rotatable rotating body 3 designed as a finger roller 23 or thumb roller for setting operating states. The operation takes place here at least by turning the rotary body 3. The rotary body you can also, for example, be designed as a mouse wheel of a computer mouse. Then the braking device 1 is part of a computer mouse.

The rotating body 3 is rotatably mounted on an axle unit 2 by means of a bearing device not shown in detail here. The rotary body 3 can also be rotatably mounted on an axle unit 2 by means of a wedge bearing device 6 designed here as a roller bearing. However, the wedge bearing device 6 is preferably not or only partially provided for the mounting of the rotary body 3 on the axle unit, but is used for the braking device 4 presented below rolling bodies here as braking bodies 44. The braking bodies 44 are designed here as cylindrical rollers 6a.

The axis unit 2 can be mounted on an object to be operated and, for example, in an interior of a motor vehicle or on a medical device or smart device. For this purpose, the axle unit 2 can have assembly means that are not shown in detail here.

It can be provided here or in the following configurations that the rotating body 3 can also be displaced in the longitudinal direction or along the axis of rotation on the axle unit 2. Operation then takes place both by turning and by pressing and/or pulling or moving the rotary knob 3.

The rotary body 3 is designed here in the manner of a sleeve and comprises a cylindrical wall and an end wall which is connected to it here in one piece. The axle unit 2 emerges at an open end face of the rotary body 3.

The finger roller 23 can be equipped with an additional part 33 indicated here by dashed lines. This results in an increase in diameter so that it is easier to rotate, for example in the case of a wheel on a computer mouse or game controller that can be rotated with one finger or a rotary wheel on a computer keyboard thumb roller.

The rotary movement of the rotary knob 3 is damped here by a magnetorheological braking device 4 arranged in a receiving space 13 inside the rotary knob 3. The braking device 4 uses a coil unit 24 to generate a magnetic field which acts on a magnetorheological medium 34 located in the receiving space 13. The magnetorheological medium 34 consists here of magnetorheological particles and a gas mixture such as air. A magnetic field leads to a local and strong crosslinking of the magnetically polarizable particles. The braking device 4 thus enables a targeted deceleration and even a complete blocking of the rotational movement. A haptic feedback can thus be provided with the braking device 4 during the rotational movement of the rotary body 3, for example by means of a correspondingly perceptible detent or by means of dynamically adjustable stops.

In order to supply and control the coil unit 24, the braking device 4 here includes an electrical connection 14, which is designed, for example, in the form of a printed circuit board or printed circuit board or as a cable line. The connection line 11 extends here through a bore 12 running in the longitudinal direction of the axle unit 2.

The receiving space 13 is sealed off from the outside here with a sealing device 7 in order to prevent magnetorheological particles of the medium 34 from escaping. The sealing device 7 closes the open end face of the rotating body 3. A (second) sealing part 37 has a small free sealing gap to the axle unit 3. The sealing parts 27, 37 are fastened here to a support structure designed as a wall 8. The sealing unit 37 can also bear directly on the inside of the rotary body 3 on the outside.

The sealing device 7 comprises the sealing unit 37, which comprises two sealing lips which, spaced apart from one another axially, protrude radially inward in this case. The axially inner sealing lip 37a is not in contact with the axle unit 2 and the axially outer sealing lip 37b is in contact with it. A radially thin sealing gap results axially on the inside, with a larger cavity in between, and the sealing lip 37b lying against it. Overall, the two sealing lips also form a type of labyrinth seal. In any case, the thin sealing gap at 37a largely or largely precludes the emergence of magnetorheological particles. The overlap 37f (cf. the enlargement of the bottom right in FIG. 2a) of the adjacent sealing lip 37b in the removed and unloaded state is small and is less than 1% or 2% here. As a result, the load from the sealing lip 37b and the frictional torque generated thereby is low and is less than half of the applied basic torque here.

The seal with the adjacent sealing lip does not have to be impervious to water or similar liquids, as there are particles inside. The sealing device doesn't have to be, either, since it doesn't contain any liquid. The sealing lip 37b is sufficient to seal off any graphite or the like that may escape. However, a minimally fitting dust seal 57 can also be provided axially outside the sensor device 5. The sensor device 5 and its magnetic ring unit 15 collects any magnetorheological particles emerging from the receiving space 13 reliably due to the magnetic field.

The seal 17 is designed here as an O-ring and surrounds the axle unit 3 radially. The seal 17 rests against the axle unit 2 and the rotating body 3. The O-ring also helps to secure. The part of the receiving space 13 filled with the particles is also sealed.

A sensor device 5 is provided here in order to monitor the rotational position of the rotary body and to be able to use it to control the braking device 4. The sensor device 5 comprises a magnetic ring unit 15 and a magnetic field sensor 25.

The magnetic ring unit 15 is diametrically polarized here (and in the other exemplary embodiments) and has a north pole and a south pole. The magnetic field sensor 25 embodied here as a Hall sensor measures the magnetic field emanating from the magnetic ring unit 15 and thus enables the angle of rotation to be reliably determined. In addition, the magnetic field sensor 25 is preferably three-dimensional here, so that in addition to the rotation, an axial displacement of the rotary body 3 relative to the axle unit 2 can also be measured. This allows both rotation and a push button function (push/pull) to be measured simultaneously with the same sensor 25. The angle can be detected via the alignment of the magnetic field and the axial position can be determined via the strength of the magnetic field (cf. FIG. 2d). However, the braking device 1 can also only be equipped with a rotating function.

The sensor device 5 is particularly advantageously integrated into the braking device 1. For this purpose, the sensor 25 is inserted into the receptacle 12 or bore 12 of the axle unit 2 here. The magnetic ring unit 15 surrounds the sensor 25 radially and is fastened to the rotary body 3 in a rotationally fixed manner. This has the advantage that not length tolerances, but only diameter tolerances that have to be precisely manufactured come into play. The radial bearing clearance between the rotating body 3 and the stationary axle unit 2 is correspondingly small and can also be easily controlled in series production.

A further advantage is that axial movements or displacements between the rotary body 3 and the axle unit 2 do not adversely affect the sensor signal, since the measurement is in the radial direction and the radial distance is essentially decisive for the quality of the measurement signal.

Here and in other configurations, the sensor 25 in the receptacle 12 can be overmolded with a plastic, for example.

In order to further improve the accommodation of the sensor 25, it is arranged here on a printed circuit board 35 or print. The coil unit 24 or its connection 14 is also contacted here on the printed circuit board 35.

Furthermore, the connecting line 11 is also connected to the printed circuit board 35, via which the entire braking device 1 is connected to the system to be operated. For example, a 6-pin or 8-pin plug can be attached to the printed circuit board 35, via which both the sensor 25 and the coil unit 24 are then connected to the corresponding controller. The signal line 45 for transmitting the sensor signal is also arranged in the connecting line 11 here.

In this way, the braking device 1 can be installed particularly easily and quickly. In order to make the entire system particularly robust with regard to errors and faults, the printed circuit board 35 can be cast in the bore 12 together with the sensor 25 in the axle unit 2.

The axle unit 2 here consists of a one-piece axle unit 2, but can also consist of two axle parts 20, 21 which are connected to one another in the axial direction. FIG. 2b shows schematic views of possible configurations. The first axle part 20 extends outward from the rotating body 3. The second axle part 21 serves as a stator and accommodates the core 26 and the electric coil unit 24. The brake bodies 44 or rollers 6a are held on the second axle part 21 adjacent to the core 26.

The wall 8 can magnetically decouple the sensor device from the coil unit 24 and the rotary body 3.

FIG. 2b shows a two-part variant. The first axle part 20 comprises an elongated tubular axial section 20a and, at an axially inner end when assembled, a fastening section 20b, which here comprises a radial section 20c and a (short) sleeve-shaped holding section 20d. Here the holding section 20d encompasses the end of the second axle part 21 and is locked and/or clamped and/or glued and/or screwed there. It is also possible for the first axle part 20 to have retaining tabs 20d for attachment to the second axle part 21. Then the fastening section 20b is not designed to be rotationally symmetrical (right part of FIG. 2b).

A push-pull function can be integrated in the exemplary embodiment according to FIG. 2a. A displacement of the first brake component in the orientation of FIG. 2a to the left leads to the axial distance of the magnetic field sensor 25 from the magnetic ring unit 15 is increased or changed.

An axial displacement changes the received signal 468 as shown in FIG. 2d. FIG. 2d shows the course of the amplitude 469 of the signal 468 detected by the magnetic field sensor 25 as a function of the axial displacement of the braking components 2, 3 (horizontal axis). An axial displacement of the magnetic field sensor 25 relative to the magnetic ring unit 15 changes the amplitude 469 of the detected signal 468. An axial displacement or a pressing down of the additional part 33 or a lateral displacement of the additional part 33 can be detected in this way. The angle of rotation can also be detected with the same sensor, the direction of the magnetic field being determined in order to detect the angle of rotation. The intensity determines the axial position. From a change in signal 468, an axial actuation of braking device 1 can therefore be inferred. This is advantageous since a single (multidimensional) Hall sensor can be used to determine the angular position and to determine an axial position.

In FIG. 2c, the sensor device 5 is shown again schematically in detail. The axle unit 2 and the rotary body are only indicated (dashed lines). The sensor device 5 is based on the decoupling device 39 on the rotatable second brake component 3, for example, magnetically decoupled from.

A shielding device 9 for shielding magnetic fields provided. The shielding device 9 consists here of a three-part shielding body 19. In addition, there is also a separating unit 29 for magnetic separation. The magnetic ring unit 15 is used to measure the orientation or the angle of rotation of the magnetorheological braking device 1. The magnetic field sensor 25 is arranged within the first axle part 20. Small relative axial displacements can also be used to detect a depression of a control button, for example.

In the embodiment shown in FIG. 2a, the wall 8 is designed to be magnetically non-conductive. This can prevent the magnetic field of the magnet ring unit 15 and the magnetic field of the coil unit 24 from adversely affecting each other. The wall 8 decouples the rotary body from the sensor device 5. The wall 8 serves here as a connection for the sealing device 7.

It is possible that a holding device 49 is provided. The holding device 49 then encloses in particular the sensor device 5 radially outwards and axially outwards and holds the magnetic ring unit 15. The holding device 49 can be made of a metal that shields magnetic fields and, for example, of a metal with a relative magnetic permeability of at least 100,000. For example, the holding device 49 is then made of a nickel-iron alloy. The holding device 49 can also be used for shielding.

The additional part 33 from FIG. 2a can also have a radially circumferential elevation with a considerably larger diameter. As a result, the braking device 1 is then also particularly suitable as a mouse wheel for a computer mouse or the like.

The rotating body 3 is in all configurations made of a magnetically particularly conductive material. The holding device 49 and the rotary body are here made of m-metal, for example. the components described here as being magnetically non-conductive consist, for example, of plastic and have a relative magnetic permeability of preferably less than 10.

The problematic fields, which can usually interfere with the measurement of the angle of rotation, are primarily the fields in the radial direction. These fields are shielded here preferably with a holding device 49 acting as a jacket or with a separate shielding body 19 (FIG. 2c) made of a suitable material, e.g., magnetically conductive steel. In addition, the magnetic field of the magnetic ring unit 15 can be further strengthened.

As a result, the magnetic ring unit 15 can be dimensioned smaller (thinner) and thus material, construction volume and production costs can be saved.

It is also possible for the holding device 49 to consist of a magnetically non-conductive material. In any case, it is then preferable for the shielding device 9 to have a one-piece or also multi-piece shielding body 19, which surrounds the magnetic ring unit 15 at least radially outwards and axially outwards and, if necessary, axially inwards, preferably without a gap, as shown in FIG. 2c or FIG. 2a, the holding device 49 can make the shielding body 19 available.

The shielding device 9 has at least one separating unit 29 which is designed to be magnetically non-conductive or only very slightly conductive. A ratio of the magnetic permeability of the shielding body 19 to the magnetic permeability of the separating unit 29 is preferably greater than 1000, but in any case greater than 10 or better greater than 100.

The construction is also improved in that the wall thickness of the shielding body 19 is varied and a distance is provided between the magnet ring unit 15 and the shielding body 19. Due to the distance between ring 15 and shielding body 19 the shielding and the reinforcement can be optimally adjusted. The material of the shielding body 19 is selected here so that it does not go into magnetic saturation, so that external magnetic fields are adequately shielded (material in saturation lets magnetic fields through like air, i.e., with the magnetic field constant mq). With an advantageous design of the distance between ring 15 and shielding body 19, the magnetic field does not close too much over shielding body 19 and the field in the center at sensor 25 is sufficiently homogeneous and is increased compared to a ring 15 of the same size or larger without shielding body 19.

A preferred dimensioning of the shielding device 9 for a mouse wheel of a computer mouse has the following dimensions, for example. The shielding body 19 is 0.5 mm thick, the distance between the shielding body and the magnet ring unit 15 is also 0.5 mm, the width of the magnet ring unit 15 is mm, and the diameter of the magnet ring unit 15 is 8 mm. In this case, the possible interference field from the coil unit 24 is 140 mT, which results in a possible error in the angle measurement of less than 0.1° (cf. earth's magnetic field: approx. 48 mT in Europe).

A further exemplary embodiment of the magnetorheological braking device 1 or the magnetorheological operating device 100 is explained with reference to FIGS. 3-10.

FIG. 3 shows a first cross section through braking device 1. Braking device 1 includes a stator, which is formed here by axle unit 2, and a rotor, which includes rotary body 3. The axle unit 2 is formed by two axle parts 20, 21 connected to one another in the axial direction, but can also be in one piece. The axle part 20 can also be referred to as a shaft and is used here to attach the operating device 100 to a console, for example. The core 26 and the electric coil unit 24 are accommodated on the part 21. The electrical coil unit 24 is here in the axial direction wrapped around the second axle part 21. The core 26 can be seen in the center. The magnetic field generated by the electrical coil unit 24 runs centrally through the core and is aligned there approximately perpendicular to the plane of the drawing.

At the first end of the second axle part 21, the first axle part 20 is connected thereto. The axle part can also be manufactured in one piece. At the opposite, second end of the axle part 21 a type of axle stub is provided here, with which the rotary body 3 is rotatably accommodated or guided on the second axle part 21. The rotating body 3 is supported here via the bearing point 412 on the outside of the rotating body 3.

Inside the rotating body 3, a receiving space 13 is formed between the second axle part 21 and the inner wall of the rotating body 3, in which a magnetorheological medium 34 with magnetorheological particles and a gas mixture is present. The rheological properties of the magnetorheological particles 34 are influenced via the magnetic field of the electric coil unit 24. A wedge bearing device 6 is also provided in the receiving space 13, which comprises brake bodies 44 designed as rollers 6a, as can be seen in FIG. 4.

The first axle part 20 consists here preferably of a metallic material and is produced as a deep-drawn part. The first axle part 20 has an elongate axial section 20a which is hollow on the inside. The magnetic field sensor 25 of the sensor device 5 is accommodated in the interior of the axial section 20a. The magnetic field sensor 25 or the magnetic field sensors 25 are arranged here on a printed circuit board 35 which is accommodated and fastened inside the axial section 20a. The printed circuit board 35 has a number of contacts and connection lines 11 with which the electrical coil unit 24 is supplied with power and via which the sensor signals of the magnetic field sensors 25 are read out.

At the inner end of the axial section 20a closes here radially outwards, a fastening portion 20b with a radial portion 20c and a holding portion 20d extending axially away therefrom. The axial section 20a is provided on a first axial side of the radial section 20c designed as an annular flange. On the opposite axial side, the holding section 20d extends radially outwards, which here is also rotationally symmetrical and is designed in the form of a sleeve. The holding section 20d surrounds a correspondingly shaped section of the second axle part 21.

The first axle part 20 and the second axle part 21 are connected to one another. In particular, the two axle parts are caulked together. It is also possible that the two axle parts 20 and 21 are screwed and/or clamped and/or glued together.

Preferably, an O-ring 17 is provided radially on the outside of the second axle part 21 between the axle part 21 and the holding portion 20d of the first axle part 20 for sealing when necessary.

The rotary body 3 extends here preferably over a significant part of the axial length of the second axle part 21 and in particular over the entire length of the second axle part 21. Here in the exemplary embodiment, the rotary body 3 projects beyond the second axle part 21 at both axial ends of the second axle part 21.

At the end facing the first axle part 20, the rotary body 3 is connected here to a holding device 49, which extends in a kind of bell shape over the first axle part 20 and around it. The holding device 49 accommodates a sealing device 7 for sealing the receiving space 13 from the outside. Furthermore, the holding device 49 carries a shielding device 9 and a magnetic ring unit 15 of the sensor device 5 accommodated thereon.

A radially inwardly projecting leg of the holding device 49 provided at the axially outer end shields the magnetic ring unit 15 axially from external magnetic influences. An immediately adjoining radial sleeve-shaped leg of the holding device 49 shields the magnetic ring unit 15 radially to the outside. As a result, the magnetic field of the magnetic ring unit 15 is influenced very little from the outside.

The holding device 49 consists here of a material with a high magnetic permeability (preferably greater than 1000 or greater than 100,000) and can consist of a similar or the same material as the rotary body 3.

Although no axial wall is formed between the magnetic ring unit 15 and the electrical coil unit 24 in the specific exemplary embodiment according to FIG. 3. This is due, among other things, to the fact that there is a considerable axial distance between the magnetic ring unit 15 and the electric coil unit 24. In addition, the first axle part 20 consists here of a plastic or a metallic material with low magnetic permeability and can consist of a paramagnetic material, for example. Due to the low magnetic permeability of the axle part 20, magnetic resistances for closing magnetic field lines in the holding device 49 are very high, so that only an extremely small interference field is present. As a result, a highly precise angle detection can take place. However, an axial wall can also be formed between the magnetic ring unit 15 and the electrical coil unit 24.

A further advantage of the braking device 1 is that the sealing device 7 rests on the first axle part 20 with a sealing lip 37b of the sealing unit 37. There is touching contact, but this only generates a small amount of friction.

On the outer circumference of the axle unit 2 (second axle part 21), a (third) sealing lip 37c is formed, which has a small here radial gap between the sealing lip 37c and the radial outer wall of the inner surface of the rotating body 3 is formed. The (dry) magnetorheological particles in the receiving space 13 are largely held back by this seal. Any particles escaping as a result are held back by the (first) sealing lip 37a, which also has a narrow gap to the axle unit 2. This is followed by the contacting sealing lip 37b, which bears against the axle part (first axle part 20) radially from the outside. Due to the structure, the contacting sealing lip only has to be in contact slightly and only generates a small amount of additional frictional torque. The proportion of the total basic torque can be reduced to ½ or ⅓ or ¼ or less. When sealing liquid, the proportion is regularly greater than ½ or even ⅔ or ¾.

If magnetorheological particles should still pass through the gap or gaps to the outside, they are held and collected by the magnetic field of the magnetic ring unit 15. There is no exit to the outside.

For an even stronger seal, the ring 37c shown (only) in FIG. 3 can also be applied to the axle part 2, which overall leads to a labyrinthine seal.

It is advantageous if the adjacent sealing lip has a small diameter. This is the case here when the sealing lip is in contact with area 20a. The outer diameter of the first axle part 20 can be reduced due to the metallic material, since the radial wall thickness of the first axle part 20 can be reduced compared to the use of a plastic material. This reduces the outside diameter and thus the friction diameter of the sealing lip 37b. This significantly reduces the frictional torque of the seal, since the diameter of the sealing surface has a quadratic effect on the resulting frictional torque.

The holding device 49 accommodates the shielding device 9 here. For this purpose, the holding device 49 has an L-shaped cross section separating unit 29 was added, which has only a low magnetic permeability. A ratio of the magnetic permeability of the shielding body 19 at the end of the holding device 49 and the separating unit 29 is preferably greater than 10 and in particular greater than 100 or greater than 1000. Inside the separating unit 29 the magnetic ring unit 15 is accommodated.

FIG. 4 shows a cross section through the braking device 1 according to FIG. 3, the cross section according to FIG. 4 being aligned perpendicular to the cross section according to FIG. 3. It can be seen here that the electrical coil unit 24 is wound around an axis that is aligned here within the plane of the drawing and transversely to the longitudinal extent of the axle device 2. The core 26 can be seen centrally within the electric coil unit 24. The electric coil unit 24 is held by a coil holder 24a.

A roller 6a is shown as a braking body 44 above and below the core 26. The rollers 6a serve as a kind of magnetic field concentrators and contribute to the wedge effect of the wedge bearing device 6.

At the right end here, the connecting lines or contacts 11 can be seen on the circuit board 3S, which is accommodated in the receptacle 12 within the first axle part 20.

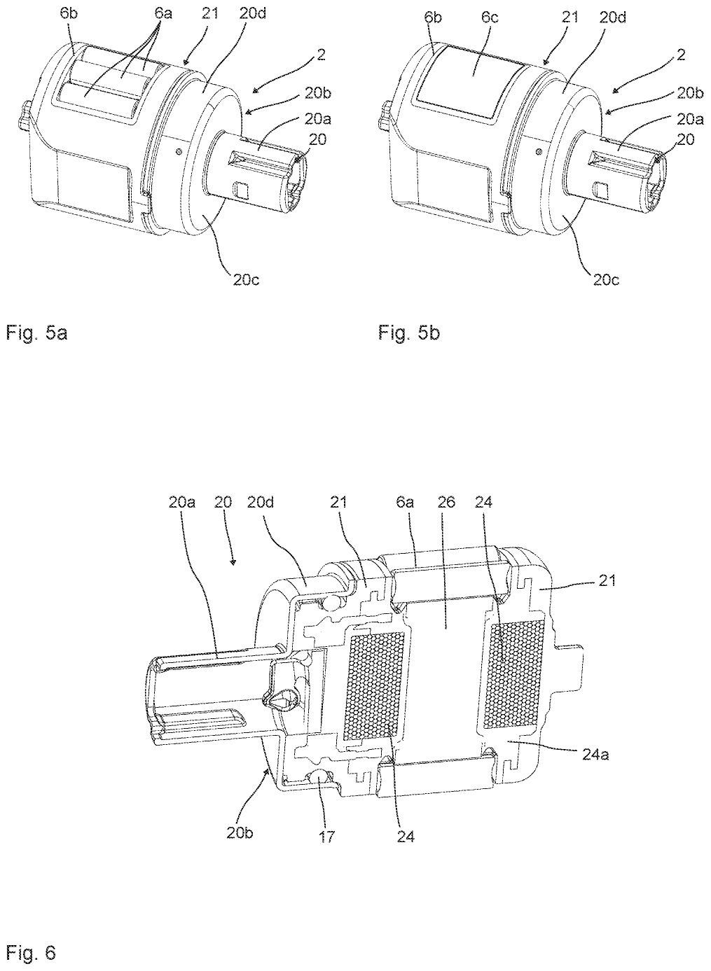

FIG. 5a shows a perspective representation of an embodiment of the axle unit 2 with the first axle part 20 and the second axle part 21, wherein the roller holder 6b and the rollers 6a accommodated thereon can be seen as brake bodies 44 on the second axle part 21.

Rotatable rollers 6a are preferably used in FIG. 5a. It is also possible for the parts 6a to be designed in the manner of rollers only radially on the outside and not to be rotatably accommodated. The components 6a (braking elements) then practically directly form part of the core 26 or are even formed in one piece with it. Then the parts 6a can form a non-circular outer contour that, e.g., can be shaped like a star and extend in preferred embodiments only over certain angular ranges of the circumference, as can also be the case with the rollers. Between the non-round outer contour and the inner wall in the rotary body, a shearing body is then formed with a variable gap height over the circumference. Such a shear gap on a “star contour” is also well suited for targeted braking. One advantage is the reduction in the number of moving parts.

FIG. 5b shows a variant in which the core 26 extends outwards and in which no rollers 6a or star contour are formed or incorporated on the core. The core may form a (partially) cylindrical outer surface. A shearing gap 6c (with a constant or variable) gap height is then formed between the outer surface and the inner surface of the rotary body 3 on at least one circumferential segment. Magnetorheological particles, which cause deceleration, are accommodated in the shearing gap.

In all cases it is possible that the magnetorheological particles in a carrier fluid such, e.g., an oil or other liquid are added. However, it is also possible for the magnetorheological particles to be contained in a gas without a carrier liquid and linked together by a targeted magnetic field.

With a shearing gap with a variable gap height on the circumference (e.g. a star contour), a higher braking torque can be generated than in a cylindrical shearing gap. An even higher braking torque can be built up via rotatable rolling elements such as the braking elements 44 or rollers 6a.

An advantage of magnetorheological particles without a carrier liquid is that a lower basic torque can be achieved since the seal requires less (or almost no) contact pressure and therefore runs more easily. Another advantage is that there is less dependence on the operating temperature. The viscosity of an oil at temperatures of −40° C. and at 120° C. is significantly different. Such dependencies disappear without the use of oil. In addition, the absolute proportion of magnetorheological particles in the gap can be increased since the volume proportion of the carrier liquid is eliminated.

FIG. 6 shows a cross section, in which it can be seen that the holding section 20d is pushed onto a corresponding section of the second axle part 21. An O-ring 17 for sealing can be seen between the holding section 20d and the second axle part 21.

If an embodiment according to FIG. 5b is present, the component 6a is practically part of the core 26 in the cross section according to FIG. 6. A configuration with such a component 6a can be advantageous if both products with rollers (as braking bodies 44) and products with a shearing gap 6c are to be manufactured in the same way. A flexible decision can then be made during assembly.

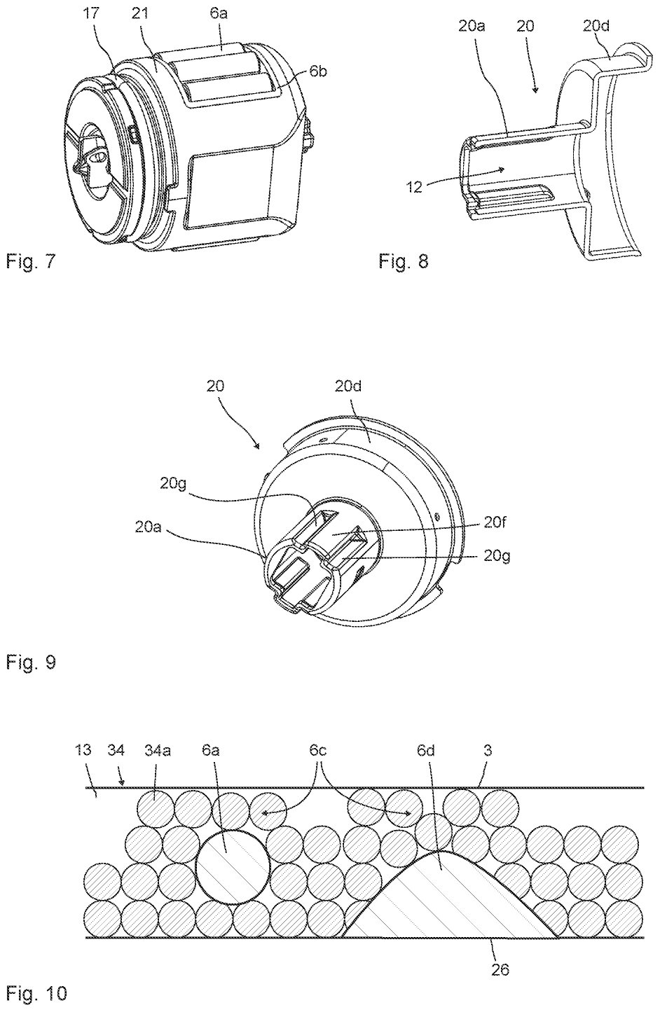

FIG. 7 shows a perspective view of the second axle part 21 with the O-ring 17 that can be seen on it, the roller holder 6b and the three rollers 6 here.

FIG. 8 shows a sectional illustration of the first axle part 20. The receptacle 12 can be seen inside the axial section 20a of the first axle part 20.

Finally, FIG. 9 shows a perspective front view of the first axle part, wherein it can be seen that the axial section 20a has a non-round outer surface here. Noses 20f and/or grooves 20g can be provided on the outer surface, which overall lead to a non-round outer surface and ensure better dissipation of the torque recorded and a torsion-proof mounting of the braking device 1 on a console 50, for example.

FIG. 10 shows a schematic representation of the magnetorheological particles 34a in the receiving space 13 between the rotary body and the core on the axle unit 2. A rotatable roller 6a and a non-rotatable and externally roller-like part connected to the core are shown as an example (not to scale). Magnetic field concentrators 6d in the shear gap 6c. The receiving space 13 is essentially or almost completely filled with magnetorheological particles 34a. Naturally, a certain amount of space must remain free. However, it has been found that it makes sense not to fill the receiving space 13 completely. Otherwise, partial blocking may also occur.

FIGS. 11e to 11f show different configurations of sealing devices 37 between the radially inner axle unit 2 and the radially outer rotary body 3 in a schematic view. In all examples, at least one sealing gap is provided between the axle unit 2 and the rotary body 3 or the holding device 49 and it lies touching at least one sealing lip.

A complex labyrinth gap is included in FIG. 11a, which extends between two sealing parts 37 and is deflected several times. The sealing gap begins here radially on the outside. In all of the embodiments, the magnetic ring 15 forms an axially closing magnetic seal 47. The sealing lip 37b rests radially on the inside against the small outer diameter of the region 20a of the first axle part 20. The resulting friction and basic torque is very low.

A complex labyrinth gap between two sealing parts 37 is also formed in FIG. 11b. Here the sealing gap starts radially on the inside of the axle unit 2. Particles that escape must follow the gap, which has been deflected several times, and past the part in contact with the sealing lip 37b.

FIG. 11c shows a simpler labyrinth gap formed between the axle unit 2 and only one sealing part, but is also deflected several times. A sealing lip 37b is again formed radially on the inside and bears against it.

FIG. 11d shows an embodiment with a thin disk-like sealing part, which extends radially from the inside to the outside and has a sealing lip 37b radially on the outside, which rests against the other, more complex sealing part 37. The materials can be matched to one another in such a way that little friction occurs. A type of sealing lip 37a ensures multiple deflection of the sealing gap.

FIG. 11e shows a relatively simple configuration in which a support ring 38 with an L-shaped cross section is fastened to the rotary body radially on the outside. The support ring 38 holds a thin disk as a sealing part 37, which forms a narrow sealing lip 37b which bears radially on the inner end. The support ring 38 forms, together with the sealing part 37, a multiply deflected gap.

Finally, FIG. 11f shows a variant in which a support ring 38 forms a thin disk axially from the outside with a sealing lip 37b lying on the inside.

Overall, the invention provides an advantageous magnetorheological braking device and an advantageous magnetorheological operating device 100.

Because a “dry” magnetorheological medium 34 is used and no oil or hydraulic fluid is included, the basic moment can be significantly reduced. In particular, the sealing device can be modified so that the basic moment is significantly reduced. If necessary, the contacting sealing lip can be configured in this way that with increasing use the lip area wears out and there is practically no more contact, whereby the basic torque is reduced again without impairing the function.

Reference list:

1 braking device
2 axle unit
3 rotating body
4 braking device
5 sensor device
6 wedge bearing device
6a roller
6b roller holder
6c shear gap
6d magnetic field concentrator
7 sealing device
8 wall
9 shielding device
11 connection line
12 receptacle, hole
13 receiving space
14 connection
15 magnet ring unit
17 seal
19 shielding body
20 first axle part
20a axial section
20b fastening section
20c radial section
20d holding section
20e retaining tab
20f nose
20g groove
21 second axle part
22 storage device
23 finger roller
24 coil unit
25 magnetic field sensor
26 core
27 sealing part
29 separation unit
30a outer diameter
30b outer diameter
33 additional part
34 medium
34a particles
35 printed circuit board
37 sealing part
37a sealing lip
37b sealing lip
37c sealing lip
37d sealing lip
37e gap width
37f overlap
38 support ring
39 decoupling device
44 brake body
45 signal line
47 magnet seal
49 holding device
50 console
57 graphite seal
59 fastening device
100 operating device
101 control button
102 thumb roller
103 computer mouse
104 joystick
105 gamepad
106 mouse wheel
190 shielding ring
412 bearing point
416 diameter
418 bearing point

1-33. (canceled)

34. A magnetorheological braking device for braking rotary movements, comprising:
at least one axle unit and at least one rotating body which is rotatable about the axle unit;
at least one magnetorheological braking device configured to a brake the rotatability of the rotating body, said at least one magnetorheological braking device having at least one coil unit;
a receiving space being formed between the axle unit and the rotating body, said receiving space being provided with a magnetorheological medium, and said magnetorheological medium having magnetorheological particles and gas as a filling medium; and
said receiving space being sealed via a sealing device, and said sealing device having a sealing unit with a contacting sealing lip between the axle unit and the rotating body.

35. The magnetorheological braking device according to claim 34, wherein the contacting sealing lip is configured to seal the magnetorheological particles within the receiving space without forming a liquid tight seal.

36. The magnetorheological braking device according to claim 34, wherein the sealing device has an elastic sealing lip with a coverage of less than 0.075 mm.

37. The magnetorheological braking device according to claim 36, wherein an extension of the unloaded elastic sealing lip in the removed state differs from an extension in the installed state less than 0.06 mm.

38. The magnetorheological braking device according to claim 36, wherein a relative difference between an extension of the unloaded sealing lip in the removed state and an extension in the installed state differs by less than 2.5%.

39. The magnetorheological braking device according to claim 36, wherein a sealing surface pressure between the elastic sealing lip and a sealing surface in the installed state is less than 0.075 MPa.

40. The magnetorheological braking device according to claim 34, wherein the sealing device has at least one non-contact sealing lip.

41. The magnetorheological braking device according to claim 34, wherein the sealing device has a non-contact labyrinth seal with at least one sealing gap.

42. The magnetorheological braking device according to claim 34, wherein the receiving space contains more than 40 percent by volume of magnetorheological particles.

43. The magnetorheological braking device according to claim 34, wherein the receiving space is filled with more than 50 percent by volume with magnetorheological particles.

44. The magnetorheological braking device according to claim 34, wherein the receiving space is filled with less than 95 percent by volume with magnetorheological particles.

45. The magnetorheological braking device according to claim 34, wherein said magnetorheological particles are predominantly carbonyl iron powder and said magnetorheological particles have a coating against corrosion.

46. The magnetorheological braking device according to claim 34, wherein the magnetorheological medium comprises graphite.

47. The magnetorheological braking device according to claim 39, wherein the sealing device has at least one sealing gap of less than to the sealing surface.

48. The magnetorheological braking device according to claim 34, further comprising a core configured to interact with the electric coil unit of the braking device.

49. The magnetorheological braking device according to claim 34, further comprising at least one sensor device configured to detect a rotational position of the rotary body.

50. The magnetorheological braking device according to claim 49, wherein the sensor device has a sensor adjacent to the receiving space at a connection point outside the receiving space.

51. The magnetorheological braking device according to claim 49, further comprising a graphite seal axially outside of the sensor device.

52. The magnetorheological braking device according to claim 34, wherein the rotating body is mounted at least partially outside of a housing, and a gap dimension between the rotating body and axle unit remains substantially unchanged when a pressure is applied to the rotating body.

53. The magnetorheological braking device according to claim 48, wherein the axle unit has a first axle part and a second axle part connected to one another in the axial direction; and said first axle part is substantially made of a paramagnetic or diamagnetic material, and said core and/or the coil unit is accommodated on the second axle part.

54. The magnetorheological braking device according to claim 49, wherein said sensor device comprises:
at least one magnetic ring unit and at least one magnetic field sensor for detecting a magnetic field of the magnetic ring unit;
at least one shielding device configured to at least partially shield the sensor device against magnetic fields, said shielding device having at least one shielding body at least partially surrounding the magnetic ring unit;
at least one separating unit between the shielding body and the magnetic ring unit, said separating unit having a lower relative magnetic permeability than the shielding body; and
at least one holding device connecting the shielding device to the rotary body in a rotationally fixed manner, said magnetic ring unit being rotationally fixed to the shielding body via the separating unit.

55. The magnetorheological braking device according to claim 54, wherein the rotary body and/or the shielding body are connected or formed in one piece with the holding device.

56. The magnetorheological braking device according to claim 54, wherein the rotating body, the shielding body, and/or the separating unit are at least partially mounted on the holding device.

57. The magnetorheological braking device according to claim 54, wherein the holding device has at least one path extending between the rotating body and the shielding body, which corresponds to at least a quarter of a maximum diameter of an electrical coil of the coil unit.

58. The magnetorheological braking device according to claim 54, wherein the shielding body is not arranged between the magnetic field sensor and the magnetic ring unit, so that the shielding body does not shield the magnetic field sensor from the magnetic field of the magnetic ring unit.

59. The magnetorheological braking device according to claim 54, wherein the shielding body surrounds the magnetic ring unit at least on a radial and/or axial outside at least in sections.

60. The magnetorheological braking device according to claim 54, wherein the shielding body as an annular shielding section with an L-shaped or U-shaped cross section.

61. The magnetorheological braking device according to claim 54, wherein the separating unit has at least one gap between the shielding body and the magnetic ring unit, at least one filling medium being arranged in the gap, and said filling medium connecting the magnetic ring unit to the shielding body in a torque-proof manner.

62. The magnetorheological braking device according to claim 54, wherein the shielding body and/or the core has a relative magnetic permeability of at least 1000 and/or at least the relative magnetic permeability of the rotary body.

63. The magnetorheological braking device according to claim 54, wherein the shielding body consists at least of partially of a nickel-iron alloy with 60% to 90% nickel and proportions of copper, molybdenum, cobalt and/or chromium.

64. The magnetorheological braking device according to claim 54, wherein the separating unit has a relative magnetic permeability of at most 1000 and/or at most one thousandth of the relative magnetic permeability of the shielding body.

65. The magnetorheological braking device according to claim 49, characterized in that the sensor device is configured to detect at least one axial position of the rotating body in relation to the axle unit.

66. The magnetorheological braking device according to claim 54, wherein:
the magnetic ring unit surrounds the magnetic field sensor at least in sections in a ring-like manner;
the magnetic field sensor is arranged with an axial offset to the axial center of the magnetic ring unit; and
the sensor device is configured to determine the axial position of the rotary body in relation to the axle unit from the intensity of the magnetic field of the magnetic ring unit detected by the magnetic field sensor and to determine an axial direction of movement of the rotating body in relation to the axle unit from a sign of a change in the intensity of the magnetic field of the magnetic ring unit.
